(19) United States
(12) Patent Application Publication
(10) Pub. No.: US 2002/0124074 A1
(43) Pub. Date: Sep. 5, 2002

(54) MONITORING OF REMOTE DATA ACCESS ON A PUBLIC COMPUTER NETWORK

(76) Inventors: JEFFREY C. LEVY, ATLANTA, GA (US); TIMOTHY F.S. COBB, ATLANTA, GA (US); JEFFREY HAYNIE, JACKSONVILLE, FL (US); JEFFREY M. RUSSELL, ATLANTA, GA (US); ANDREW WILLIAM MARKHAM, ATLANTA, GA (US)

Correspondence Address: FULBRIGHT & JAWORSKI, LLP, 666 FIFTH AVE, NEW YORK, NY, 10103-3198, US

(21) Appl. No.: 09/006,141

(22) Filed: Jan. 13, 1998

Related U.S. Application Data
(63) Continuation-in-part of application No. 08/781,087, filed on Jan. 9, 1997, now abandoned.

(51) Int. Cl. G06F 17/40

(52) U.S. Cl. 709/224; 709/227

(57) ABSTRACT

On a data network, use of remote data resources by users is monitored by rerouting a resource access request message, generated on a client system, through a logging module, collecting information about the message, and transmitting the message to a remote data resource server.

### BACKGROUND OF THE INVENTION

The invention relates to measuring visits to a web site and personal characteristics of the visitors.

The Internet is a worldwide collection of interconnected computer networks. Every computer connected to the Internet is assigned a unique numerical address (known as the “IP address”) which permits data to be transmitted in a point-to-point fashion between any two such computers. In addition, each computer may be assigned a “host name” which is an alphanumeric string which corresponds to an IP address.

One rapidly growing use of the Internet is the display of web pages. Web pages are data files which contain coded audiovisual information, program instructions, and hypertext links. A hypertext link is information about the location of a web page on a web site. The data in a web page is typically encoded in a format known as Hypertext Markup Language (HTML).

A web site is a computer system which is connected to the Internet, which has one or more web pages stored in its memory, and which has the capability to transmit those web pages to another computer in response to a request received from that computer via the Internet.

A client computer is a computer system which is connected to the Internet and which has the ability to display audiovisual information encoded in a web page. A user may access web pages by using a piece of software on a client computer called a browser. A browser communicates over the Internet with another program called a web server which runs on a web site. In response to instructions received from the user, the browser sends a request to a web server to transmit a specific web page from the web site on which the web server resides to the client computer. The web server responds by transmitting the web page to the client computer.

When the contents of a web page are received at a client computer, the browser translates it to an audiovisual format and displays it for the user. If the web page being displayed contains hypertext links to other web pages, the browser may also retrieve these web pages and display them as elements of the first page. If the web page contains program instructions, the browser may execute those instructions.

Typically, a browser permits a user to request the display of a particular web page via the Internet by specifying the universal resource locator (URL) of the web page. The URL is a string of characters which identifies a unique logical location of the web page on the Internet.

A browser also typically permits a user to retrieve and display a web page by using a pointing device (e.g. a mouse) to point to a location on a video display corresponding to a hypertext link in an already retrieved web page. By this method, a user who only knows one URL may nonetheless access a succession of web pages by following the hypertext links contained in each page. The set of all such linked pages on the Internet has come to be known as the World Wide Web.

In addition to displaying information contained in web pages, browsers will typically, in response to coded instructions in a web page, permit a user to enter information via a keyboard and to transmit that information to a web site via the Internet. This functionality permits web pages to act as “forms” which can be filled out by users and returned to web sites.

In addition to the “online” browsing scenario explained above, certain browsers also support offline browsing through a mechanism referred to here as a “channel mechanism.” This mechanism permits certain URLs to be identified as “channels” and enables the browser to “subscribe” to them. When the browser is subscribed to a channel, this causes the web browser to retrieve on a regular basis (hourly, for example) information from the web site identified by the URL associated with the channel, and to store the information in a cache located on the client computer. When the user instructs the browser to view a particular channel, information stored in the cache is displayed for the user. Since new channel information is retrieved by the browser on a regular basis, a channel mechanism provides a useful way for a user to keep track of dynamic information, such as a stock ticker or a newswire.

Web browsers which provide a channel mechanism are also capable of keeping track of a user's access to the channel information stored in the cache. For example, the Netcaster plug-in to the Netscape Navigator browser includes a capability known as Off-line Channel Data Logging (OCDL). When OCDL is activated, Netcaster will record each instance in which a user accesses data located in the cache, including the time of the access and the location from which the information in the cache was originally retrieved. The LOG element of the Channel Definition Format for Microsoft Internet Explorer provides a similar ability to track user accesses to cached information.

All of the communication between browsers and web servers on the Internet takes place by means of a suite of packet switching protocols known as Transport Control Protocol/Internet Protocol or TCP/IP. The TCP/IP protocol permits two computers on the Internet to establish one or more virtual communication circuits between them, known as “sockets.”

Because there exist a number of different physical mechanisms by which computers can be connected to the Internet (e.g. telephone line, ISDN, high speed dedicated lines, ethernet), application programs such as web browsers typically do not directly implement the TCP/IP protocol, but rely instead on a “network interface module,” a standard platform-specific software library which implements a set of platform and medium-independent network communication functions. Thus, every time that a web browser sends or receives data to or from a web site, it does so through a series of function calls to the network interface.

Web browsers communicate with web servers by exchanging messages in a language known as Hypertext Transport Protocol, or HTTP. HTTP messages can be used by a browser to send data to or request data from a web site. In order to retrieve information on a particular web page, a browser will generate an HTTP GET message. In order to transmit information to a web site (e.g. user entries on a form), a browser will generate an HTTP POST message. HTTP GET and POST messages include within them (explicitly or implicitly) the URL of the page being accessed.

The World Wide Web has certain unique characteristics which give it the potential to revolutionize the manner in which advertisers reach their desired audiences. Unlike any other advertising medium, the World Wide Web permits the creation of advertising messages which are permanent (i.e. they are available 24 hours a day and are not transient like broadcast messages), yet which are infinitely revisable (i.e. they can be updated in a matter of seconds at negligible cost, unlike messages in print media). The World Wide Web is also unique in its ability to reach international audiences without any additional cost and, through its interactive functionality, to provide messages which are geared to the specific interests expressed by individual users in real time.

One obstacle to the more widespread use of advertising on the World Wide Web is the lack of any reliable means for advertisers to determine how effectively a message is reaching its intended audience. Traditional advertising media sell space to advertisers based on readership or viewership surveys. These media surveys allow advertisers to estimate both the size of medium's audience, and its demographic and psychographic characteristics.

Media surveys are also essential to content providers (e.g. magazine publishers and television networks). A content provider sells space to an advertiser based on its ability to attract the audience which the advertiser wishes to reach. A content provider may expend significant resources on new content in the expectation that it will attract a bigger or (demographically) better audience. But such an expenditure can only be profitable to the content provider if the provider can prove to advertisers that the content is having the desired effect. Without this means, content providers will have little incentive to improve the quality of their content.

While circulation figures and media surveys are widely used to measure the effectiveness of print and broadcast media, they are less practical for measuring viewing patterns on the World Wide Web. Users who view web pages are, for all practical purposes, anonymous. Browsers normally transmit no information to web servers which would reliably identify the name or even the location of a particular user. Thus, the operators of web servers have nothing equivalent to a magazine's subscription list on which to ground demographic or psychographic claims or to base a survey. Moreover, because of the multitude of web pages and the transient and happenstance nature of a user's interaction with any given page, random telephone or E-mail surveys are unlikely to produce accurate and detailed information about World Wide Web viewing patterns.

Currently known techniques for measuring the viewership of web sites have shortcomings because they cannot provide any demographic or psychographic information about the viewers and they do not always accurately determine the number of advertising messages to which a viewer has been exposed.

For example, one known technique for measuring web site popularity has been simply to count the number of times that a web site has been “hit” by an outside request to transmit web page data. The measure resulting from this technique can be misleading, however, because oftentimes it is necessary for a single web site to be “hit” multiple times in order to display a single screenful of web page data.

An improved measurement technique counts the number of “impressions” made by a web page by determining how many times that a web page has displayed advertising messages to a user. This measure is still unsatisfactory. It does not produce any demographic or psychographic data about the users who are viewing the web page in question. Moreover, this method cannot distinguish between a single person (or even an automated computer program) accessing the same page numerous times, and numerous users accessing the page a single time. Thus, it is unable to determine the number of distinct users who access a page and is also subject to manipulation by persons with fraudulent or malicious intent.

Moreover, neither of these methods permits monitoring of a given user's pattern of web site access. They cannot, for example, show the order in which a user access a series of web sites, nor can they determine the interval between the time a user access a given first web site, and the time the user accesses a next web site.

Another known technique monitors computer usage patterns by installing software on a user's computer which logs every operation performed by the user, and saves this information to the computer's permanent memory. At specified intervals, the user saves this information to a floppy disk which is then mailed to a centralized location where the data is compiled.

### SUMMARY OF THE INVENTION

The present invention provides a method for monitoring use of remote data resources by users on a data network. A resource access request message generated on a client system (e.g., an HTTP GET or POST message) is rerouted through a logging module, information about the message is collected, and the message is transmitted over the data network to a remote data resource server.

Preferred implementations may include one or more of the following features.

The message may be rerouted by trapping a call to a network interface module and transferring control to the logging module. The message may be rerouted by routing the message to a proxy server. The remote data resource may be a web page. The message may be generated by a web browser. User identification data may be registered on a registration server. User identification data may be registered on a registration server by transmitting a registration form from a registration server to the client system, prompting the user to complete the registration form, and transmitting registration form data from the client system to the registration server. The registration form data may include demographic information about the user. The user identification data may include demographic information about the user. Demographic information for the user may be combined with information collected about rerouted messages. Reports may be generated from the result of combining the demographic information and the information collected about rerouted messages. Information about the message may be sent to a data collection server. The information about the message may be sent to the data collection server shortly after the message is rerouted. The information about the message may be stored temporarily and transmitted to the data collection server at a later time. One or more reports of information received by the data collection server may be compiled. One or more of the reports may be made available on a server. The reports may be made available on a server by requesting a user ID from a requester and transmitting a report associated with the user ID from the web site to the requester. The server may be a web site. The datestamp of a log file on the client system may be compared with specified time and if the log file was modified since the specified time, information from the log file transmitted to the data collection server. The log file may contain information about use of cached data by a user. The information about the message may include information identifying the user. The time interval since the last time information was collected about a rerouted message may be determined and, if it is greater than a given size, the user may be requested to identify him or herself before transmitting the message over the data network to the remote data resource server. The network may be the Internet.

Among the advantages of this invention are that it permits data to be collected without user intervention, and that it permits web site access data to be collected as the site is being accessed, thus permitting real time monitoring of web site access patterns.

Another advantage of this method is that it permits data about web site access patterns to be correlated with demographic information about users, so that statistical reports can be generated about the behavior of different demographic groups.

The invention also has the advantage that initial registration and setup of participating users can be done inexpensively and in a mostly automated fashion over the Internet.

Another advantage of the invention is that the customer reports generated from the data collected can be distributed over the Internet at very low cost, and the reports can be tailored to the needs and authorization of particular customers.

The invention may be implemented in hardware or software, or a combination of both. Preferably, the technique is implemented in computer programs executing on programmable computers that each include a processor, a storage medium readable by the processor (including volatile and non-volatile memory and/or storage elements), at least one input device, and at least one output device. Program code is applied to data entered using the input device to perform the functions described above and to generate output information. The output information is applied to one or more output devices.

Each program is preferably implemented in a high level procedural or object oriented programming language to communicate with a computer system. However, the programs can be implemented in assembly or machine language, if desired. In any case, the language may be a compiled or interpreted language.

Each such computer program is preferably stored on a storage medium or device (e.g., ROM or magnetic disk) that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner.

Other features and advantages of the invention will become apparent from the following description of preferred embodiments, including the drawings, and from the claims.

### BRIEF DESCRIPTION OF THE DRAWINGS

FIG. 1 is a block diagram showing a system of networked computers including client computers, web sites, and a registration server.

FIG. 2 is a block diagram of a typical client computer containing a browser and a network interface module.

FIG. 3 is block diagram of the registration site, including a network interface module, a registration server, and a database.

FIG. 4 is a flow chart showing the technique by which a user registers with the registration server using a browser on a client computer.

FIG. 4a is a list of the information requested of new users by the registration server.

FIG. 5 is a flow chart showing the technique used by the datatrap initialization module.

FIG. 5a is a flow chart showing the technique used by FakeGetProcAddress in the Windows 95 implementation.

FIG. 6 is a flow chart showing the technique used by the send_trap routine in the datatrap module.

FIG. 7 is a block diagram of a client computer after the datatrap module has been installed.

FIG. 8 is a flow chart showing the technique used by client_set_session of the datatrap module.

FIG. 8a is a block diagram of a session_info record.

FIG. 8b is a block diagram of a NEW_SESSION message.

FIG. 8c is a block diagram of a NEW_SESSION_CONFIRMED message.

FIG. 9 is a flow chart showing the technique used by the registration_set_session routine of the registration server.

FIG. 9a is a block diagram of record in the connections table maintained by the registration server.

FIG. 10 is a flow chart showing the technique used by the client_log_get routine of the datatrap module.

FIG. 10a is a block diagram of a LOG message.

FIG. 10b is a block diagram of a hit_data record.

FIG. 11 is a flow chart showing the technique used by the registration_log_hit routine.

FIG. 12 is a flow chart showing an alternate technique used by send_trap to monitor the user's web page viewing patterns.

FIG. 13 is a flow chart showing the technique used by the routine client_log_channel_get.

FIG. 14 is a flow chart showing the technique used by the routine client_log_channel_activity.

### DESCRIPTION OF THE PREFERRED EMBODIMENTS

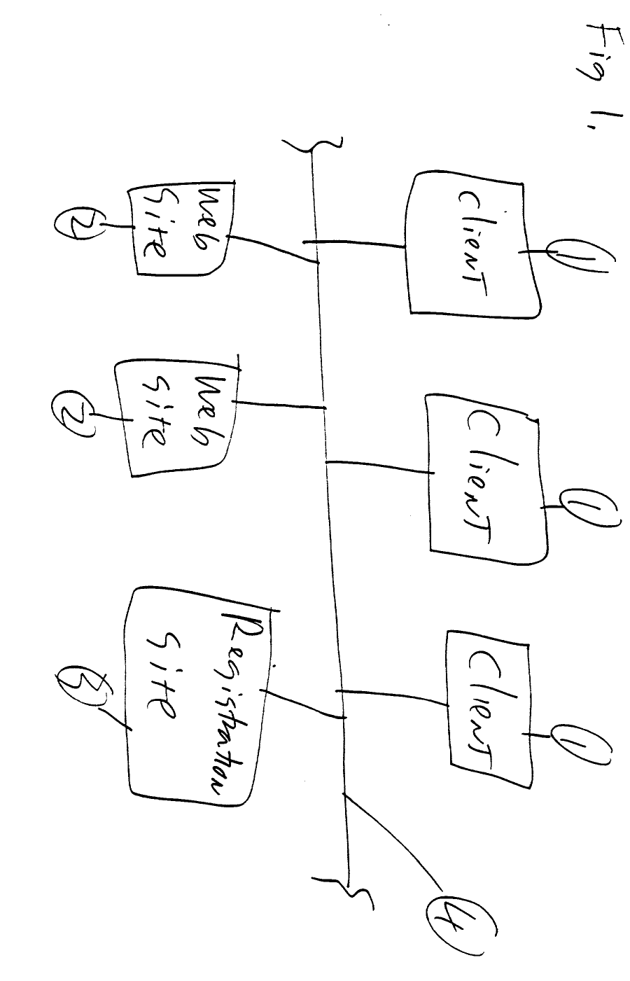

Shown in FIG. 1 is a simplified diagram of the Internet. A plurality of client computers 1 are connected via a network 4 to a plurality of web sites 2 and a registration site 3.

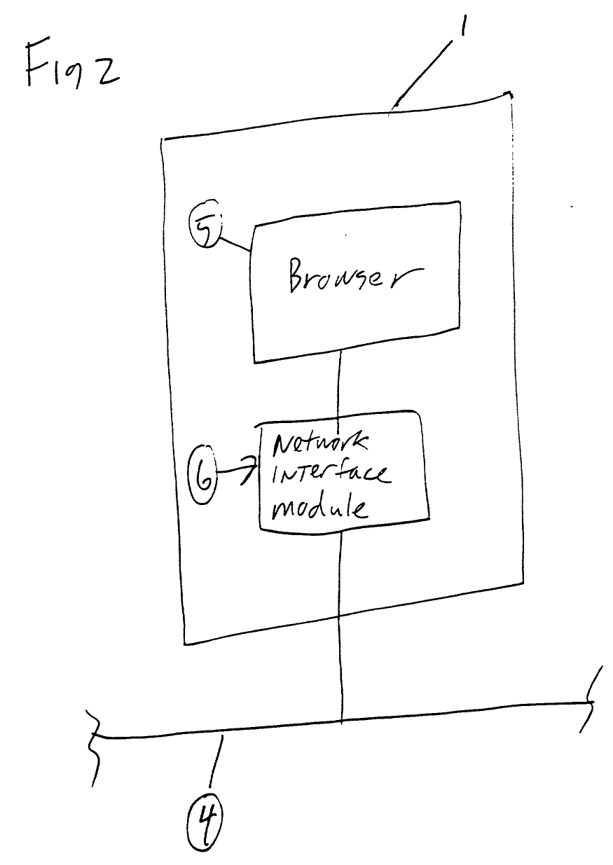

Shown in FIG. 2 is a simplified diagram of a client computer. It contains a web browser application 5 which can send and receive messages to and from a network 4 by calling functions in a network interface module 6 (e.g. the Winsock network interface library running under Windows 95). In particular, the web browser application can send and receive HTTP messages.

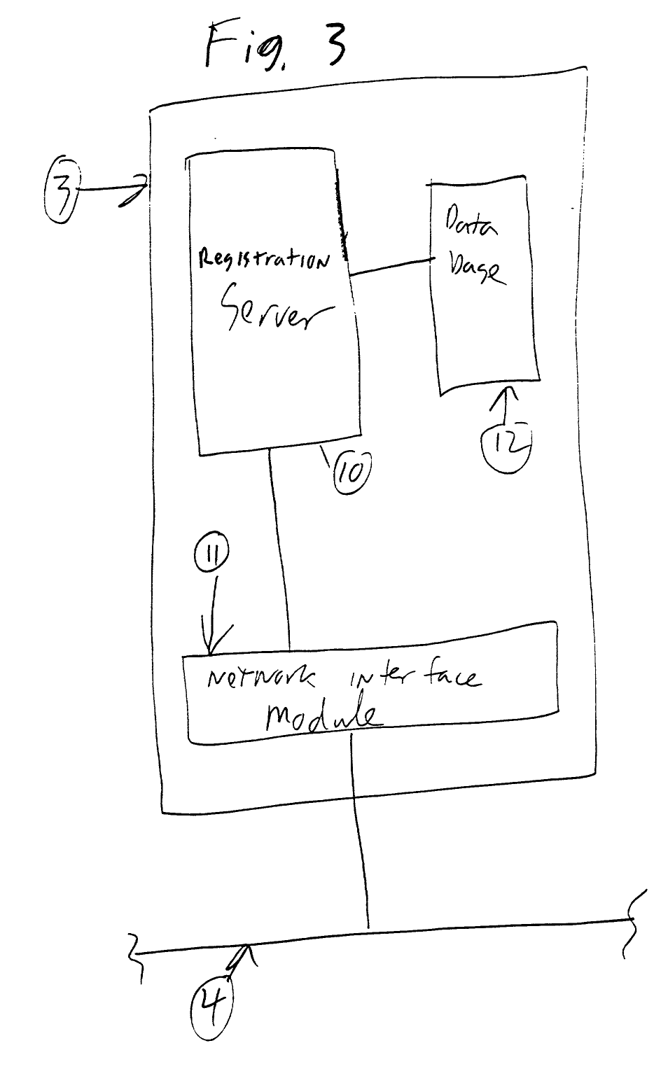

Shown in FIG. 3 is a simplified diagram of a registration site. It contains a registration server program 10 which can send and receive messages to and from a network by calling functions in a network interface module 11. The registration server program can also write records to a database 12.

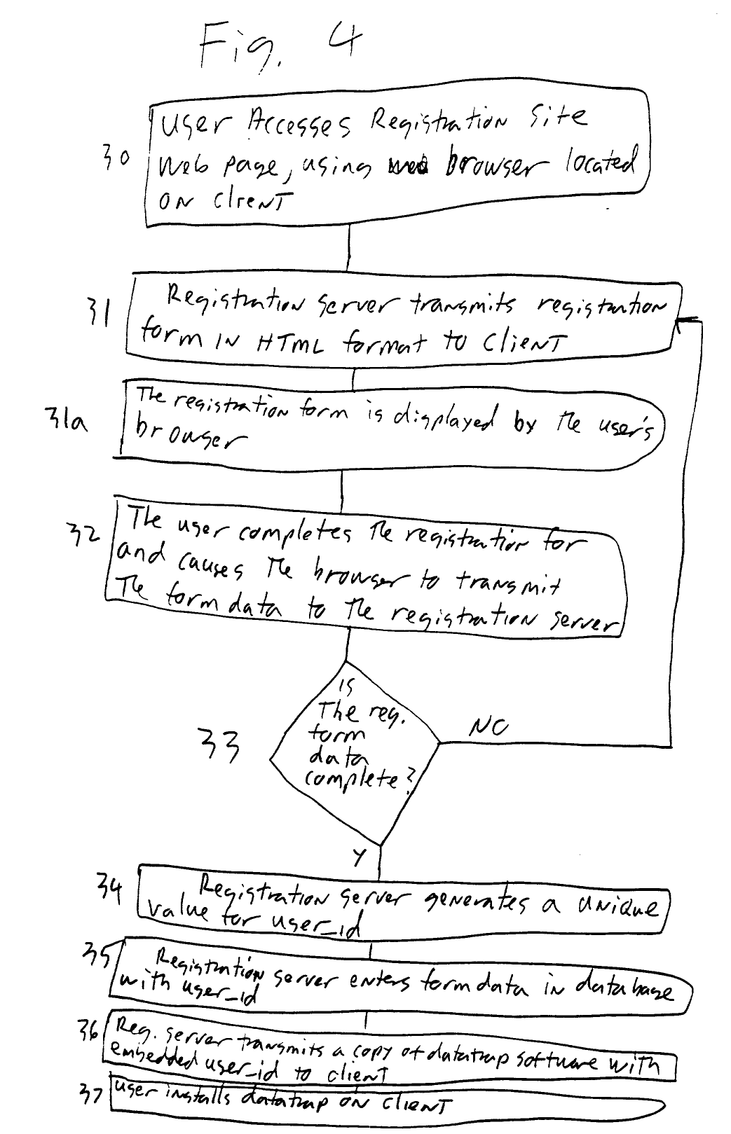

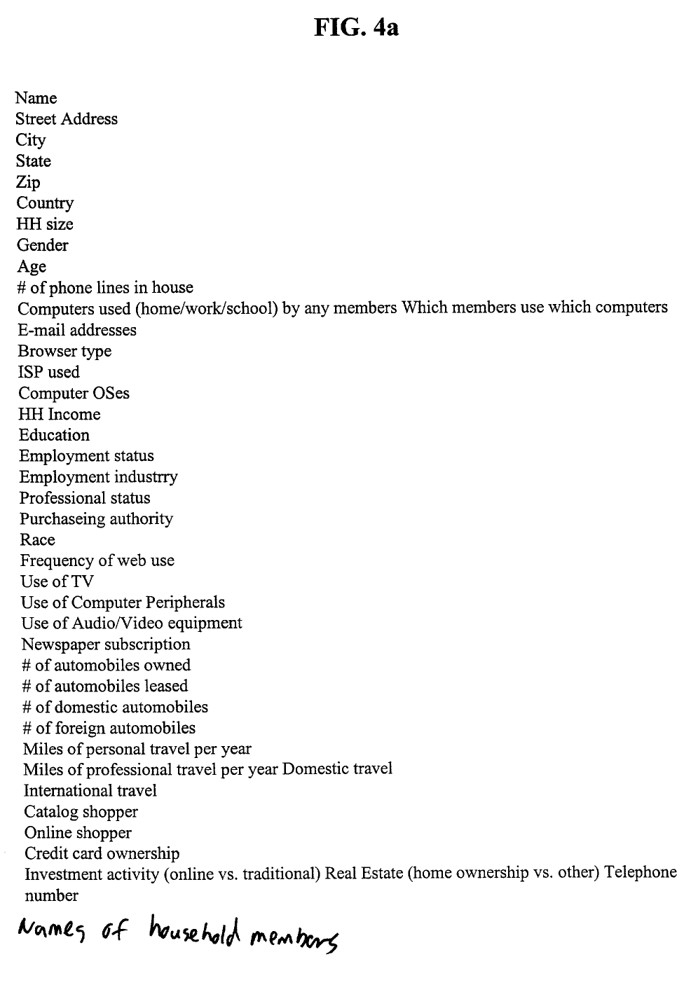

In order for a user's web browsing to be monitored, the user must register with the registration server. The process of registering a new user is shown in FIG. 4. The user first accesses the registration server's web page using the web browser located on the user's client computer (step 30). The registration server then transmits to the user's client computer a registration form in HTML format (step 31). This form is displayed by the user's web browser (step 31a). The form instructs the user to provide data about him or herself. A list of the information requested is illustrated in FIG. 4a. The user fills out the form using the web browser, and transmits the resulting data back to the registration server (step 32). The data are checked for completeness (step 33). If the data are not complete, the registration server transmits a new form to complete (step 31). If the data are complete, the registration server sets the variable user_id to a unique value (step 34) and creates a record in the database consisting of user_id and the data obtained from the registration form (step 35). The registration server then creates a copy of the datatrap module (described herein) with the value of user_id embedded within it, and transmits this copy to the user's client computer (step 36). Also embedded within the datatrap module are one or more member_ids. The user_id serves to identify the household or office in which the client system is located, and the member_ids serve to identify particular individual users within the householder or office. Once the user installs the datatrap module on his or her machine (step 37), monitoring will commence after the next reboot of the client computer.

The precise steps involved in installing the datatrap module on the user's client computer will depend on which type of operating system the client computer supports. In all cases, the principle is the same. The datatrap module is stored on the client computer's hard disk drive. The client computer's bootstrap routine, which contains all of the commands which are executed when the client computer is powered up or reset, is then modified to include a command to execute the datatrap module's initialization submodule.

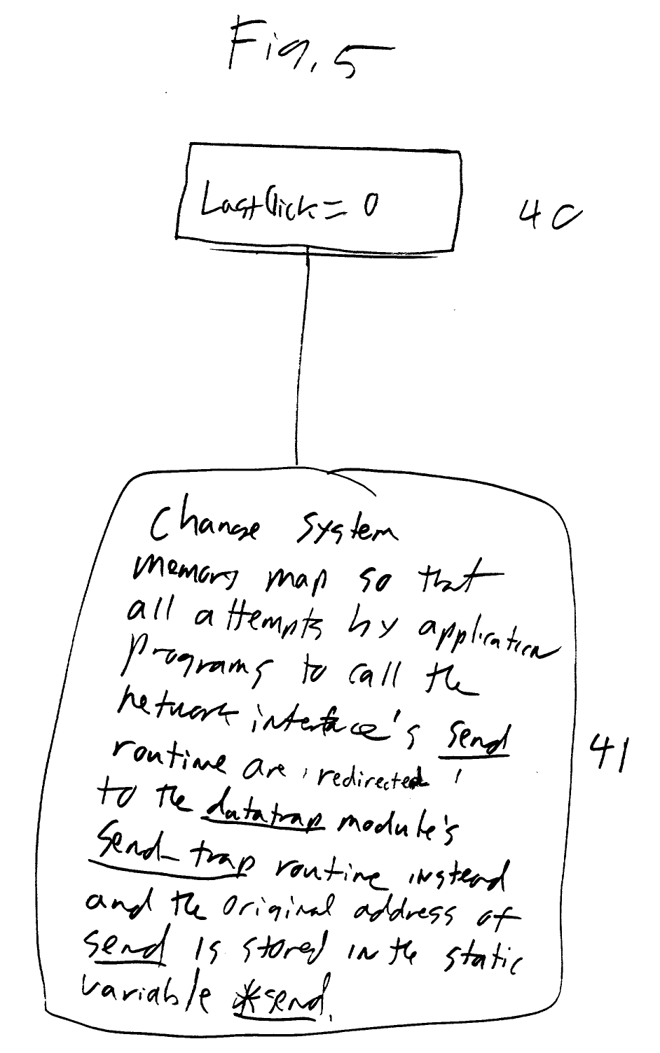

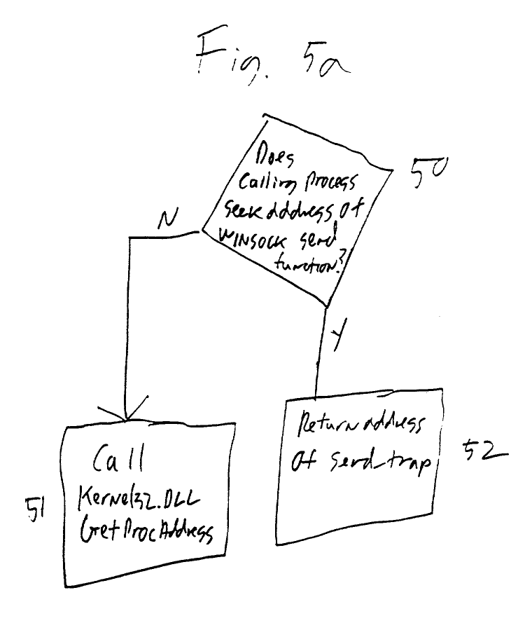

FIG. 5 shows the technique used by the datatrap initialization submodule. First, the static variable LastClick is set to zero (step 40). Next, the operating system's memory map is modified so that all attempts by application programs to call the network interface's send routine are redirected to the datatrap module's send_trap routine instead, and the original address of send is stored in a static variable *send (step 41).

The manner in which this redirection is accomplished will depend on the structure of the operating system. For example, in Windows 95, the memory address which normally points to the KERNEL32.DLL function GetProcAddress is set to point instead to a function within the datatrap module called FakeGetProcAddress. The function GetProcAddress is ordinarily called by all application program processes to obtain the entry points for dynamic link library (DLL) functions. With this change, these processes will instead call FakeGetProcAddress. As illustrated in FIG. 5a, FakeGetProcAddress examines the function for which the calling process seeks the entry point (step 50). If the function is the WINSOCK send function, the address returned is the address for send_trap (thus causing the application program to call send_trap when it is trying to call send) (step 52). If the function is any other function, FakeGetProcAddress simply calls GetProcAddress which returns the actual function address sought by the calling process (step 51).

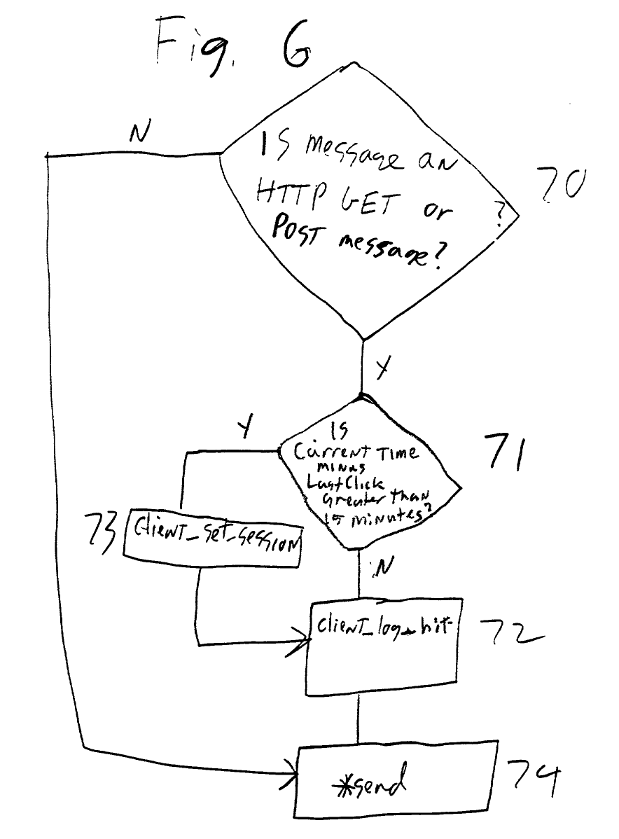

FIG. 6 shows the technique used by send_trap to monitor the user's web page viewing patterns. When send_trap is called, it first determines whether the data that the application program is attempting to send is an HTTP GET or POST message (step 70). If it is not an HTTP GET or POST message, send_trap immediately calls *send and exits (step 74). If the message is an HTTP GET or POST message, then the variable LastClick is compared with the current time (step 71). If LastClick is more than 15 minutes prior to the current time (indicating that no GET or POST messages have been initiated in the last 15 minutes), then the routine client_set_session is executed (step 73). After client_set_session has been executed, or if LastClick is less than fifteen minutes prior to the current time, the routine client_log_hit is executed (step 72). Next, *send is executed and send_trap exits (step 74).

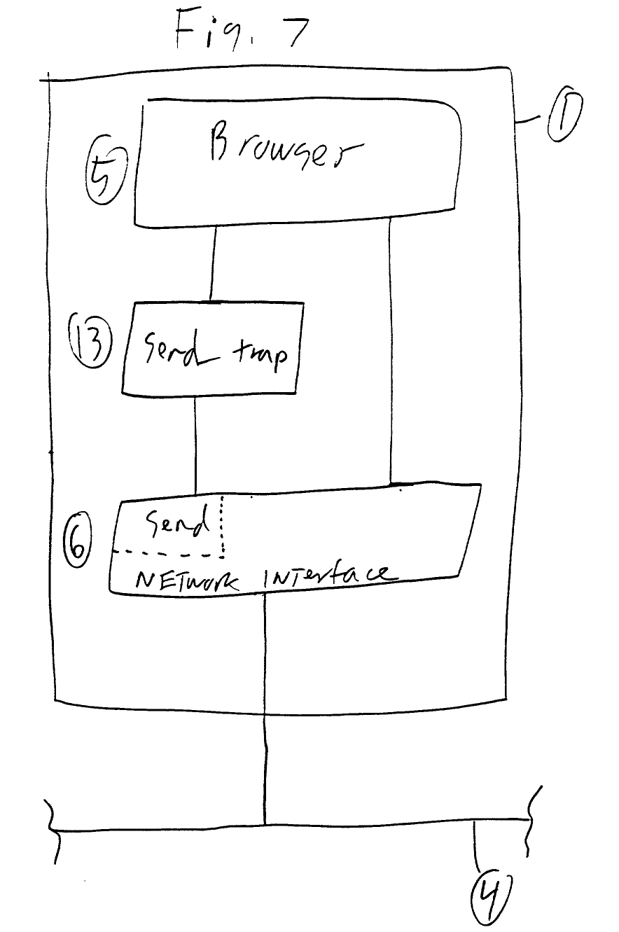

FIG. 7 shows conceptually the change in the client computer system configuration after datatrap has been installed. The browser 5 still accesses the network through the network interface module 7, except that calls to the module's send routine are first processed through the send_trap module before being passed on send.

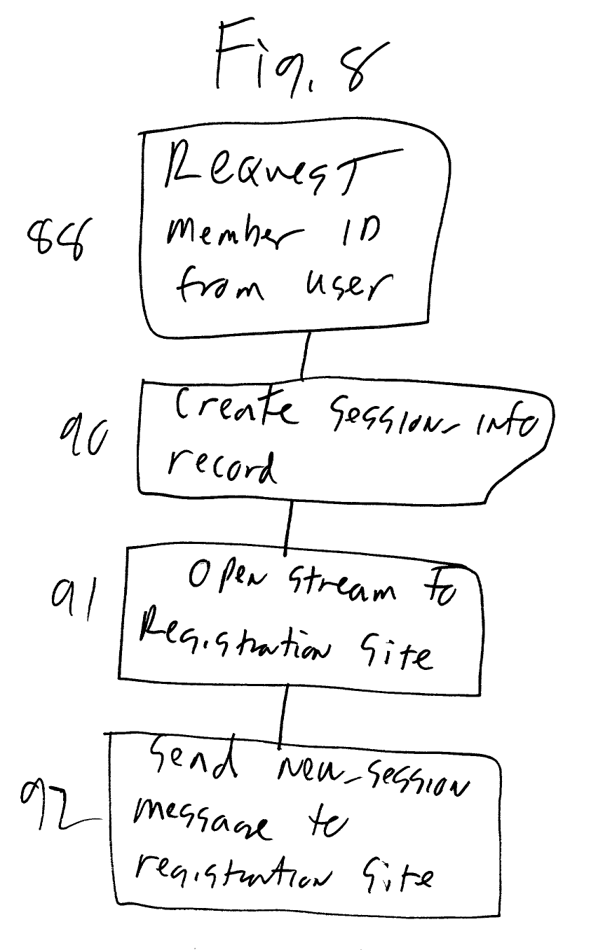

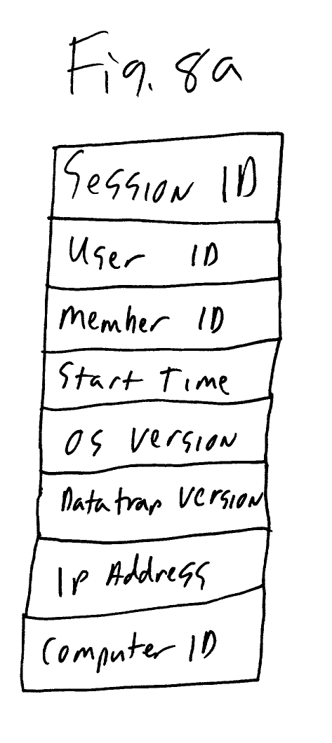

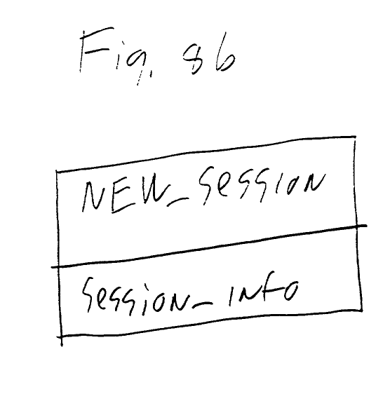

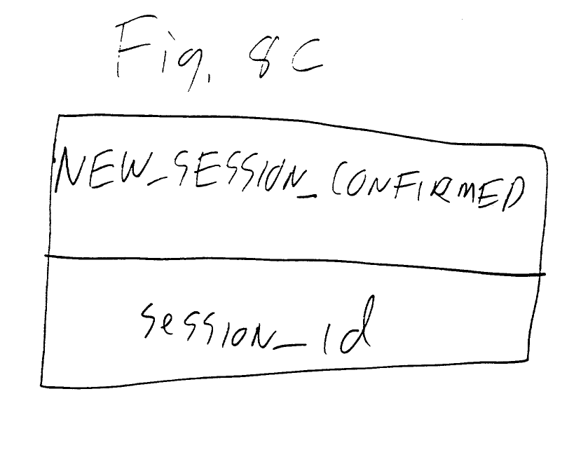

FIG. 8 shows the technique used by client_set_session. First, the user is queried to identify him or herself by selecting from one of a list of member_ids which have been embedded in the datatrap module (step 88). Next, a record session_info is created (step 90). As illustrated in FIG. 8a, session_info contains the session_id (a unique number generated by the datatrap module), the user_id (which identifies the household and is permanently embedded in the datatrap module), the member_id (which identifies the member of the household), the current time and date, the client computer's operating system, the version of the datatrap module which is being executed, the Internet Protocol address of the client computer, and the computer_id (which identifies the computer in the household and is permanently embedded in the datatrap module). Next, the network interface module is used to open up a network socket between the client computer and the registration site (step 91). Once the socket has been established, a NEW_SESSION message is sent to the registration site (step 92). As shown in FIG. 8b, the NEW_SESSION message contains a token “NEW_SESSION” and the session_info record.

In one embodiment, Client_set_session then waits until a NEW_SESSION CONFIRMED message is received from the registration site until proceeding. This embodiment will be referred to as the “handshake embodiment.” In an alternative embodiment, receipt of the NEW_SESSION message by the registration site is assumed, and a NEW_SESSION_CONFIRMED message is not transmitted to acknowledge receipt by the registration site. This embodiment will be referred to as the “no handshake embodiment.”

As show in FIG. 8c, in the handshake embodiment, the NEW_SESSION_CONFIRMED message contains a “NEW_SESSION_CONFIRMED” token, and the session_id value. When this message is received, Client_set_session exits.

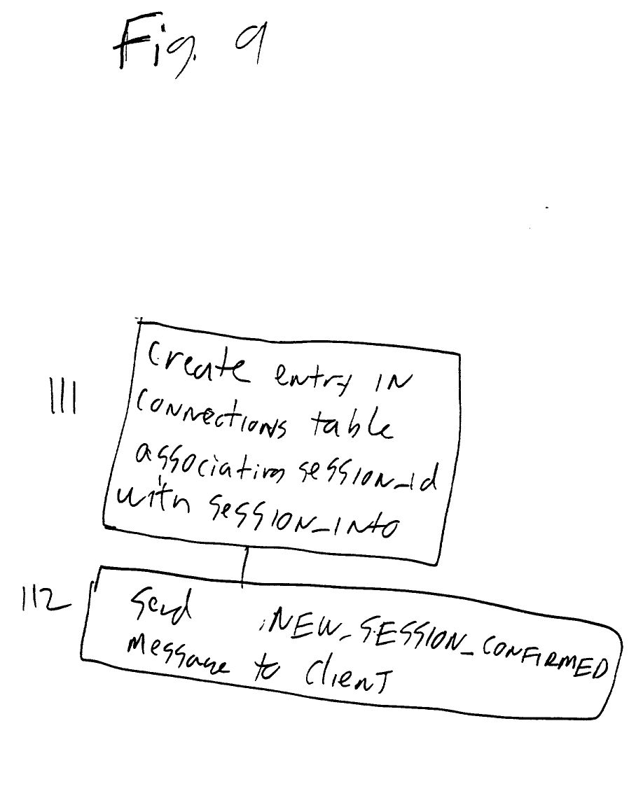

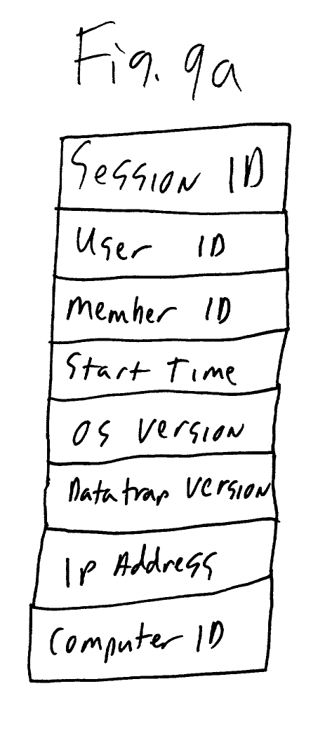

FIG. 9 shows the technique used, in the handshake embodiment by the registration server to process NEW_SESSION messages from client computers. First, a connection data record is created in a static table connections, having as one field the value of session_id contained in the session_info record transmitted with the NEW_SESSION message, as a second field the value of the local variable connection_id (which is created by the network interface and identifies the network socket between the registration server and the client computer), and having as its remaining fields the remaining field values of the session_info record which were transmitted by the client computer (step 111). The structure of a connection data record is illustrated in FIG. 9a. Next, a NEW_SESSION_CONFIRMED message is sent to the client computer, containing the value of session_id as its contents (step 112).

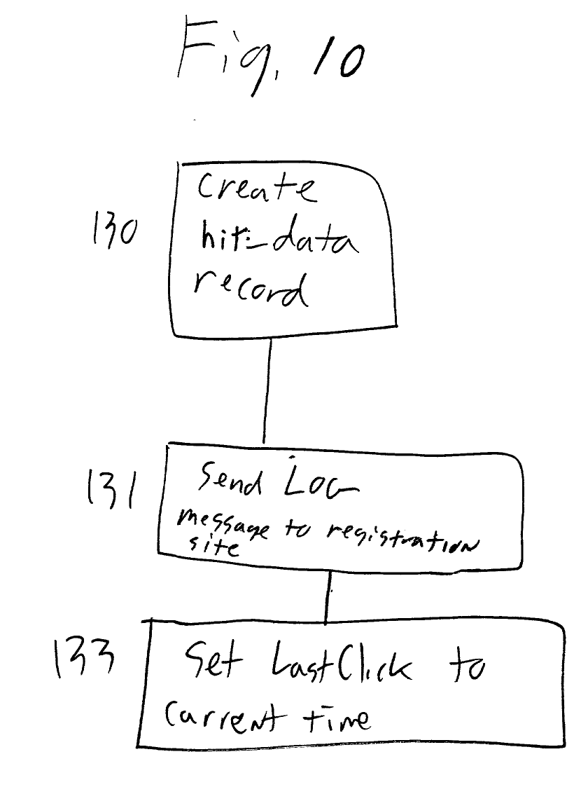

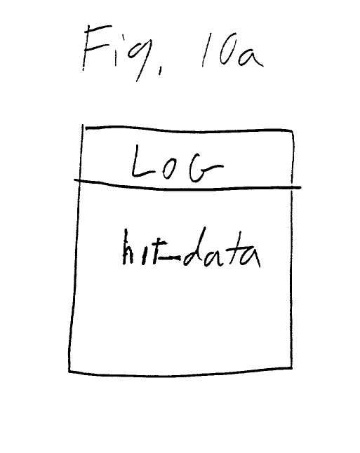

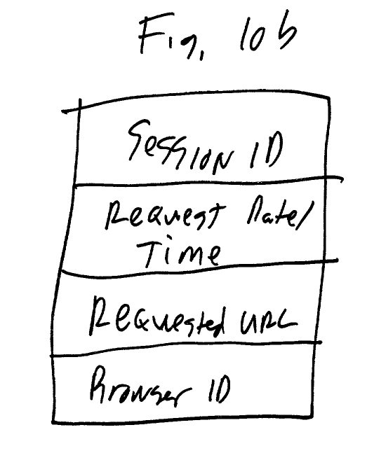

FIG. 10 shows the technique used by client_log_hit to log GET and POST messages to the registration server. A record hit_data is created (step 130). As illustrated in FIG. 10b, this record consists of the current value of session_id, the date and time, the URL which the GET or POST message being processed seeks to access, and a token identifying the type of browser being used. Then, a LOG message is sent to the registration server using *send (step 131). As shown in FIG. 10a, a LOG message consists of the token “LOG” and the contents of hit_data. Next, the variable LastClick is set equal to the current time.

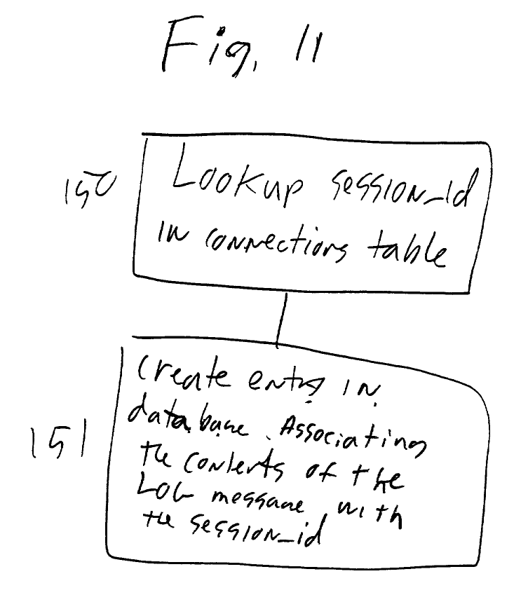

FIG. 11 shows the technique used by the registration server to process incoming LOG messages. First, the connection record in connections corresponding to the session_id value in the LOG message is retrieved (step 150). Then, a record is created in the database associating the data contained in the LOG message with the session_id (step 151).

The registration server continuously collects data from client computers on which the datatrap module has been installed. From time to time, a snapshot of this data may be taken (consisting, e.g. of all of the transactions recorded within a given time period), and statistical reports may be generated, showing patterns of web page access by users within relevant demographic groups (e.g. frequency of access to a page by members of a given group) as well as patterns of sequential web page access (e.g. statistics indicating how frequently a user accessing a given first web page will follow a hypertext link on that page to a given second page).

Third parties (e.g. customers of the registration server operator) may access the statistical reports generated by the registration server by access via the Internet, using a “report” web page on the registration site. This web page requires that the third party enter a password (and transmit it back to the registration site) before being permitted access to the requested reports. Passwords are supplied to authorized third parties by the registration site operator. Once the third party has entered a valid password, it is provided with a menu of possible reports in HTML format. The types of reports available may be varied depending on the level of service to which the user has subscribed.

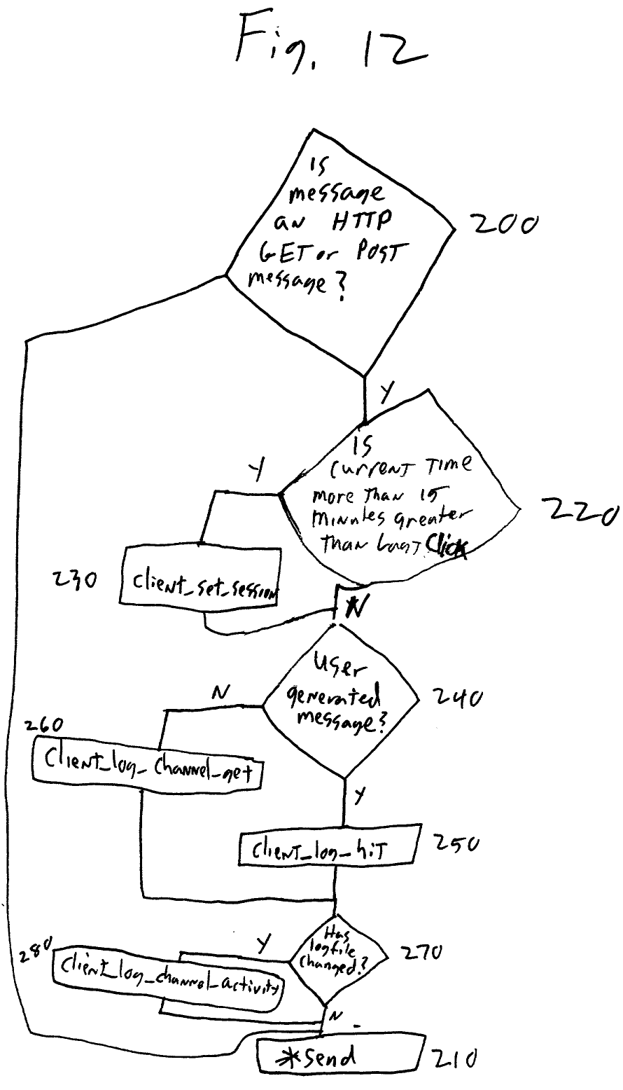

In a browser with a channel mechanism, the technique used by send_trap to monitor the user's web page viewing patterns is modified as follows. Referring to FIG. 12, when send_trap is first called, it determines whether the data that the application program is attempting to send is an HTTP GET or POST message (step 200). If it is not an HTTP GET or POST message, send_trap immediately calls *send (step 210) and exits. If it is an HTTP GET or POST message, then the variable LastClick is compared to the current time (step 220). If the current time is more than 15 minutes greater than LastClick, then the routine client_set_session is executed (step 230). After client_set_session has been executed, or if the current time is not more than 15 minutes greater than LastClick, then the message is checked to determine whether the message is a user initiated message (i.e. one generated in response to a user seeking to access a data resource) or whether it is generated by a channel mechanism for updating channel information in a cache (step 240).

The steps taken by the send_trap routine to determine whether the message is a user initiated message or not may vary depending on the implementation of the channel mechanism in the browser, but one of the following three techniques may be used. The send_trap routine may keep a master list of URLs associated with channels (either generated by the user or derived from channel mechanism configuration files), and may consider all messages directed to such URLs as messages generated by a channel mechanism.

Alternatively, the GET and POST messages generated by a channel mechanism may contain information specially identifying them as messages generated by a channel mechanism. For example, they may contain a “user agent” header field value which is unique to a channel mechanism. In such a case, send_trap would scan the content of messages to determine whether such identifying information is present.

Alternatively, send_trap may keep a running log of the times when messages are sent to particular URLs. Each time send_trap receives a GET or POST message, it determines the amount of time between the current message and any prior messages to the same URL. If send_trap determines that there is a sufficient regularity in the messages being directed to a given URL (for example, if three such messages have been sent at precisely hourly intervals), it determines that such messages are being generated by a channel mechanism, and places that URL on a list of channel mechanism URLs. Future messages directed at that URL are then considered to be generated by a channel mechanism.

Referring again to FIG. 12, if send_trap determines that the message was user generated, the routine client log hit is executed (step 250), otherwise, the routine client_log_channel_get is executed (step 260). Next, the datestamp of the log file maintained by the channel mechanism is checked (step 270). If the datestamp indicates that the log file has been changed since the last time send_trap was called, the routine client_log_channel_activity is executed (step 280). Next, *send is executed (step 210) and send_trap exits.

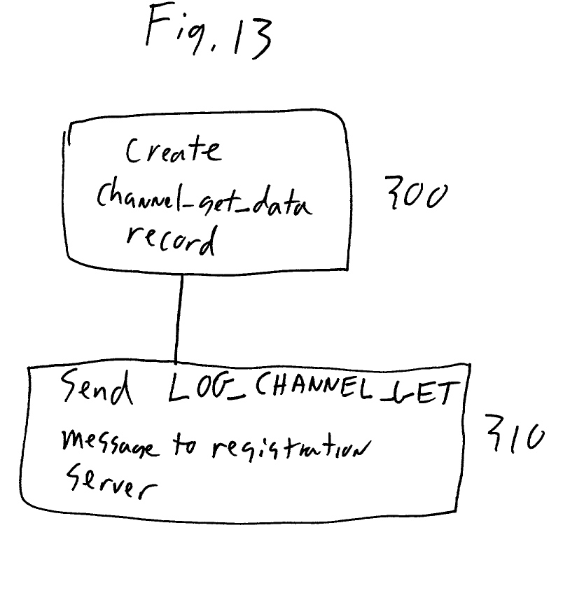

FIG. 13 shows the steps taken by the routine client_log_channel_get. A record channel_get_data is created (step 300). The record includes the current value of session_id, the date, and the URL which the GET or POST message being processed seeks to access. Then a LOG_CHANNEL_GET message is sent to the registration server using *send, which includes the token “LOG_CHANNEL_GET” along with the contents of the channel_get_data record (step 310). When LOG_CHANNEL_GET messages are received by the registration server they are processed in the same manner as LOG messages.

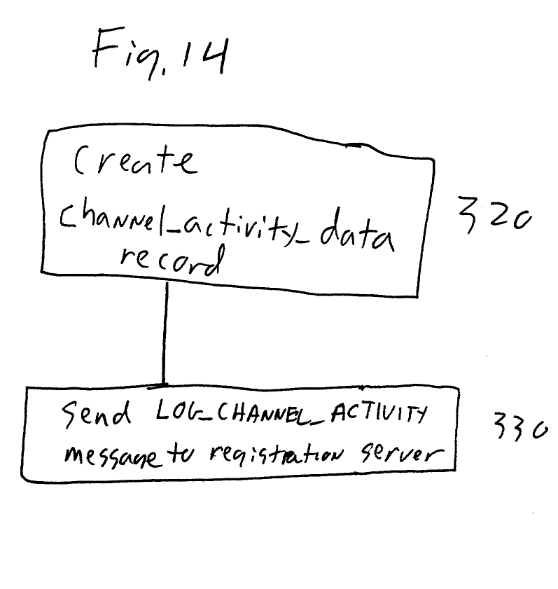

FIG. 14 shows the steps taken by the routine client_log_channel_activity. A record channel_activity_data is created (step 320). The record includes the current value of session_id, the date, and the current contents of the channel mechanism log file. Then a LOG_CHANNEL_ACTIVITY message is sent to the registration server using *send, which includes the token “LOG CHANNEL_ACTIVITY” along with the contents of the channel_activity_data record (step 330). When LOG_CHANNEL_ACTIVITY messages are received by the registration server, they are processed in the same manner as LOG messages.

Other embodiments of the invention are within the following claims. For example, user registration can take place by mail, or through a direct dialup connection, rather than through the online mechanism described above. Instead of instantaneously transmitting a LOG message to the registration server each time the user accesses a web page, the datatrap module could accumulate a number of “hits” and transmit them to the registration server at given intervals of time or after a fixed number of “hits.” The functions of the registration site might be carried out from a number of different physical web servers (e.g., registration at one or more registration servers, data collection at one or more data collection servers, and report display at one or more report servers).

In another embodiment, calls to the network interface are not trapped. Instead, the web browser is instructed to use a “proxy server.” A proxy server is software running on a computer connected to the Internet which accepts HTTP messages from a client computer, and simply re-emits them onto the Internet. In this embodiment, software is installed on the client computer which acts as a proxy server for the client computer, but which also has the HTTP GET and POST message logging capability of datatrap described above. All HTTP messages sent by the client computer are rerouted through the proxy server, which issues LOG messages to the data collection server before passing the message on to the Internet.

Alternatively, the proxy server software may be installed on a remote system. Since a remote proxy server does not have direct access to files on the client system, a “mini-server” software module is installed on the client system. This “mini-server” responds to file transfer protocol (FTP) “fetch” requests from the proxy server, thus permitting the proxy server to retrieve a channel mechanism log file for transmission to the registration server. It should be noted that in this alternative embodiment, an instance of a proxy server program must be run to support each computer that is being monitored. This may be accomplished, for example, by running multiple instances of the proxy server program on a single proxy server system, and having each instance associated with a particular network port on the system. Each computer to be monitored is programmed to use a specific port to communicate with the proxy server.

Because a datatrap module in a remote proxy server program cannot directly access the client system operating system, it cannot directly perform the step of requesting the user to identify him or herself, indicated as step 88 above. Instead, the datatrap module obtains this information by transmitting an HTML form requesting this information to the client server. (The HTML form is sent in response to the GET or POST message which causes client_set_session to be called.) The user enters the information in the form and clicks on a “submit” button, which causes the form information to be transferred back to the proxy server.

The client computer may be a single-user or a multi-user platform, or it may be an embedded computer, such as in a consumer television, personal digital assistant, Internet surfing, or special purpose appliance product. Web pages may reside on a wide area network, a local area network, or on a single file system.

What is claimed is:

1. On a data network, to which are connected a plurality of client systems and a plurality of remote data resource servers, wherein the client systems access remote data resources on the remote data resource servers by issuing resource access request messages, a method for monitoring use of the remote data resources by users of the client systems, the method comprising:
rerouting a resource access request message, generated on a client system, to a logging module;
having the logging module collect information about the rerouted message; and
transmitting the message over the data network to a remote data resource server.

2. The method of claim 1, wherein rerouting the message comprises:
trapping a call to a network interface module and transferring control to the logging module.

3. The method of claim 1, wherein rerouting the message comprises:
routing the message to a proxy server.

4. The method of claim 1, wherein the remote data resource is a web page.

5. The method of claim 1, wherein the message is generated by a web browser.

6. The method of claim 1, wherein the logging module identifies the user issuing the rerouted message.

7. The method of claim 6, further comprising:
registering user identification data on a registration server.

8. The method of claim 7, wherein registering user identification data on a registration server comprises:
transmitting a registration form from a registration server to the client system;
prompting the user to complete the registration form; and
transmitting registration form data from the client system to the registration server.

9. The method of claim 8, wherein registration form data includes demographic information about the user.

10. The method of claim 7, wherein the user identification data includes demographic information about the user.

11. The method of claim 10, further comprising combining the demographic information for the users with information collected about rerouted messages.

12. The method of claim 11, further comprising generating reports from the result of combining the demographic information and the information collected about rerouted messages.

13. The method of claim 1, further comprising sending the collected information to a data collection server.

14. The method of claim 13, wherein the information about the message is sent to the data collection server shortly after the message is rerouted.

15. The method of claim 13, wherein the information about the message is stored temporarily and transmitted to a data collection server at a later time.

16. The method of claim 1, further comprising compiling one or more reports of information received by the data collection server.

17. The method of claim 16, further comprising making one or more of the reports available on a server.

18. The method of claim 17, further comprising:
requesting a user ID from a requester;
transmitting a report associated with the user ID from the web site to the requester.

19. The method of claim 17, wherein the server is a web site.

20. The method of claim 13, further comprising:
comparing the datestamp of a log file on the client system with the last time that the logging module collected data about a rerouted message; and
if the log file was modified since the last time that the logging module collected data about a rerouted message, transmitting information from the log file to the data collection server.

21. The method of claim 20, wherein the log file contains information about use of cached data by a user.

22. The method of claim 1, wherein information about the message includes information identifying the user.

23. The method of claim 22, further comprising the steps of:
determining whether the time interval since the last time information was collected about a rerouted message is greater than a given size; and
if the time interval is greater than a given size, requesting the user to identify him or herself before transmitting the message over the data network to the remote data resource server.

24. The method of claim 1 wherein the network is the Internet.
